(19) United States
(12) Patent Application Publication
(10) Pub. No.: US 2026/0164186 A1
(43) Pub. Date: Jun. 11, 2026

(54) SOUND CONVERSION DEVICE AND MICROPHONE

(71) Applicants: Yuki UCHIDA, Shiga (JP); Yoshitaka TATARA, Shiga (JP); Ayumu MURAKAMI, Shiga (JP); Naoki YOSHIDA, Shiga (JP)

(72) Inventors: Yuki UCHIDA, Shiga (JP); Yoshitaka TATARA, Shiga (JP); Ayumu MURAKAMI, Shiga (JP); Naoki YOSHIDA, Shiga (JP)

(73) Assignee: MMI SEMICONDUCTOR CO., LTD., Tokyo (JP)

(21) Appl. No.: 19/410,359

(22) Filed: Dec. 5, 2025

(30) Foreign Application Priority Data
Dec. 11, 2024 (JP) 2024-217023

(51) Int. Cl. H04R 19/04; H04R 1/04; H04R 7/04; H04R 7/18

(52) U.S. Cl. CPC H04R 19/04; H04R 1/04; H04R 7/04; H04R 7/18; H04R 2201/003

(57) ABSTRACT

A sound conversion device includes a substrate having a cavity, a thin film including a deformable part disposed to cover the cavity and configured to deform in response to a change in pressure inside the cavity, and a fixed part connected to the deformable part and fixed to the substrate, and a back plate facing the thin film in a thickness direction of the substrate, disposed on a side opposite to the substrate with respect to the thin film, and having a plurality of holes formed in the back plate, wherein the back plate includes a plate having the plurality of holes and facing the thin film, and a lateral wall disposed to surround the plurality of holes, and extending from the plate toward the thin film.

The present application is based on and claims priority to Japanese patent application no. 2024-217023 filed on Dec. 11, 2024, with the Japan Patent Office, the entire contents of which are hereby incorporated by reference.

### BACKGROUND OF THE INVENTION

### 1. Field of the Invention

The disclosures herein relate to sound conversion devices and microphones.

### 2. Description of the Related Art

For example, an acoustic transducer including a substrate having a cavity, a vibrating electrode plate disposed above the substrate, and a fixed electrode plate facing the vibrating electrode plate above the substrate is known (see, e.g., Patent Literature (PTL) 1).

There is also known an acoustic transducer including a substrate having an opening, a back plate arranged so as to face the opening of the substrate, and a vibrating electrode film arranged to face the back plate with a gap provided between the vibrating electrode film and the back plate (see, e.g., PTL 2). The acoustic transducer converts displacement of the vibrating electrode film into a change in capacitance between the vibrating electrode film and the back plate. The back plate is provided with a projection extending toward the vibrating electrode film.

In a sound conversion device according to the related art, when the vibration of a thin film which is a vibrating electrode plate increases, there is a possibility that the thin film and the back plate may be damaged due to a collision between the thin film and the back plate.

The present disclosure aims to provide a sound conversion device capable of reducing the vibration of the thin film.

### CITATION LIST

### Patent Literature

[PTL 1] Japanese Laid-Open Patent Publication no. 2015-56832
[PTL 2] International Publication no. 2016-143867

### SUMMARY OF THE INVENTION

A sound conversion device includes a substrate having a cavity, a thin film including a deformable part disposed to cover the cavity and configured to deform in response to a change in pressure inside the cavity, and a fixed part connected to the deformable part and fixed to the substrate, and a back plate facing the thin film in a thickness direction of the substrate, disposed on a side opposite to the substrate with respect to the thin film, and having a plurality of holes formed in the back plate, wherein the back plate includes a plate having the plurality of holes and facing the thin film, and a lateral wall disposed to surround the plurality of holes, and extending from the plate toward the thin film.

The present disclosure provides a sound conversion device capable of reducing the vibration of the thin film.

### BRIEF DESCRIPTION OF THE DRAWINGS

FIG. 1 is an exploded perspective view illustrating a sound conversion device according to a first embodiment;

FIG. 2 is a plan view illustrating the sound conversion device according to the first embodiment;

FIG. 3 is a plan view illustrating a diaphragm;

FIG. 4 is a cross-sectional view illustrating a section taken along a line IV-IV in FIG. 2;

FIG. 5 is a plan view illustrating an arrangement of a lateral wall formed on a back plate;

FIG. 6 is a partially enlarged plan view illustrating an enlarged portion of the back plate;

FIG. 7 is a cross-sectional view illustrating a section taken along the line IV-IV in FIG. 2, and a drawing illustrating a state in which the lateral wall and a stopper are in contact with a movable film;

FIG. 8 is a cross-sectional view illustrating a sound conversion device according to a comparative example, and a drawing illustrating a state in which a stopper is in contact with a movable film;

FIG. 9 is a cross-sectional view illustrating a sound conversion device according to a second embodiment, and a drawing illustrating a state in which a lateral wall and a stopper are in contact with a movable film;

FIG. 10 is a cross-sectional view illustrating a sound conversion device according to a third embodiment;

FIG. 11 is a cross-sectional view illustrating the sound conversion device according to a third embodiment, and a drawing illustrating a state in which a lateral wall and a stopper are in contact with a movable film;

FIG. 12 is a partially enlarged plan view illustrating an enlarged portion of a back plate of a sound conversion device according to a fourth embodiment;

FIG. 13 is a cross-sectional view illustrating a MEMS microphone according to a fifth embodiment; and

FIG. 14 is a cross-sectional view illustrating a MEMS microphone according to a sixth embodiment.

### DESCRIPTION OF THE PREFERRED EMBODIMENTS

In the following, embodiments of the present invention will be described with reference to the accompanying drawings. In the present description and drawings, the same or corresponding constituent elements are denoted with the same reference numerals, and redundant description thereabout may be omitted.

### Sound Conversion Device 100 According to First Embodiment

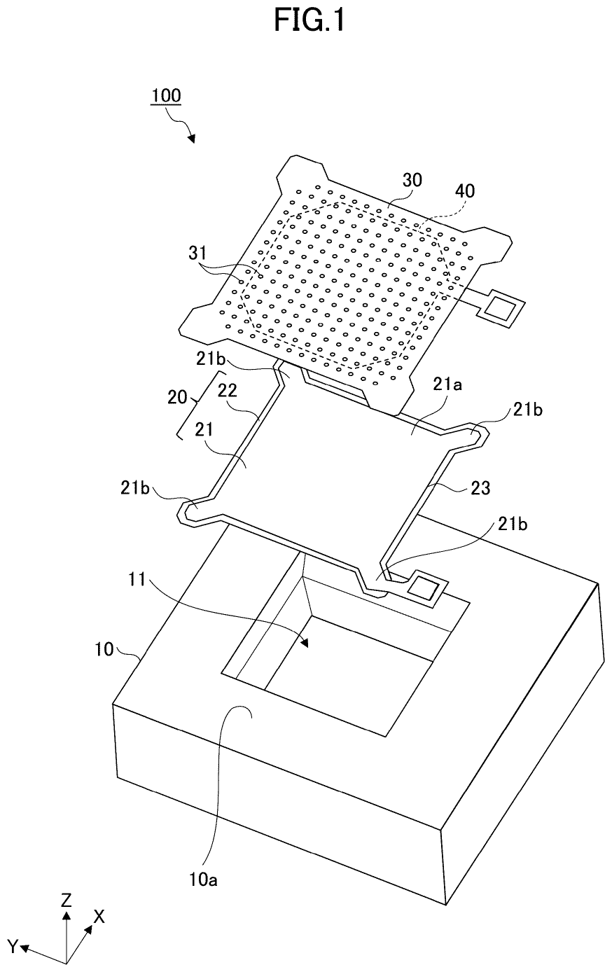

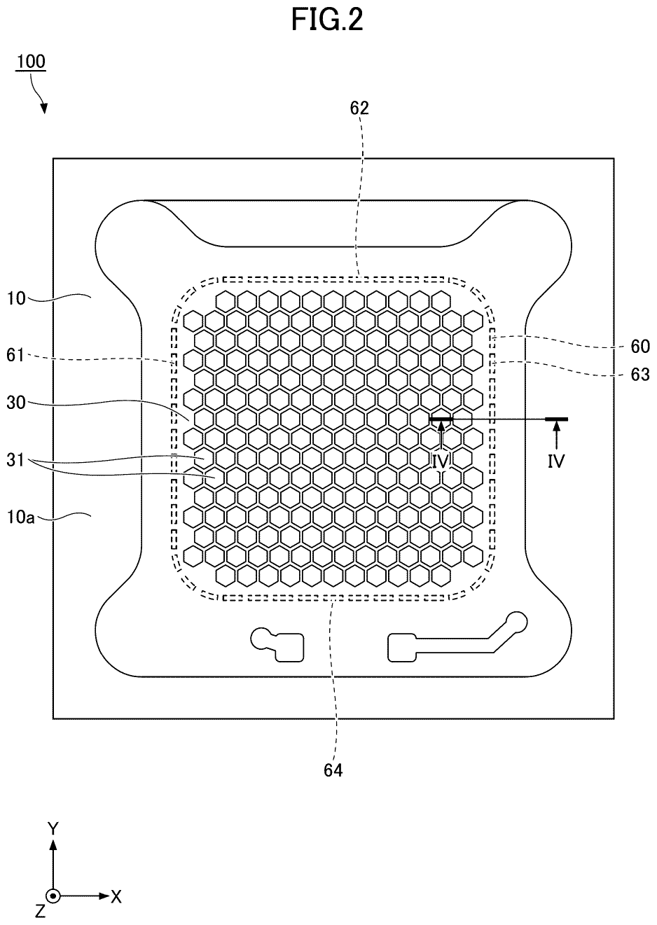

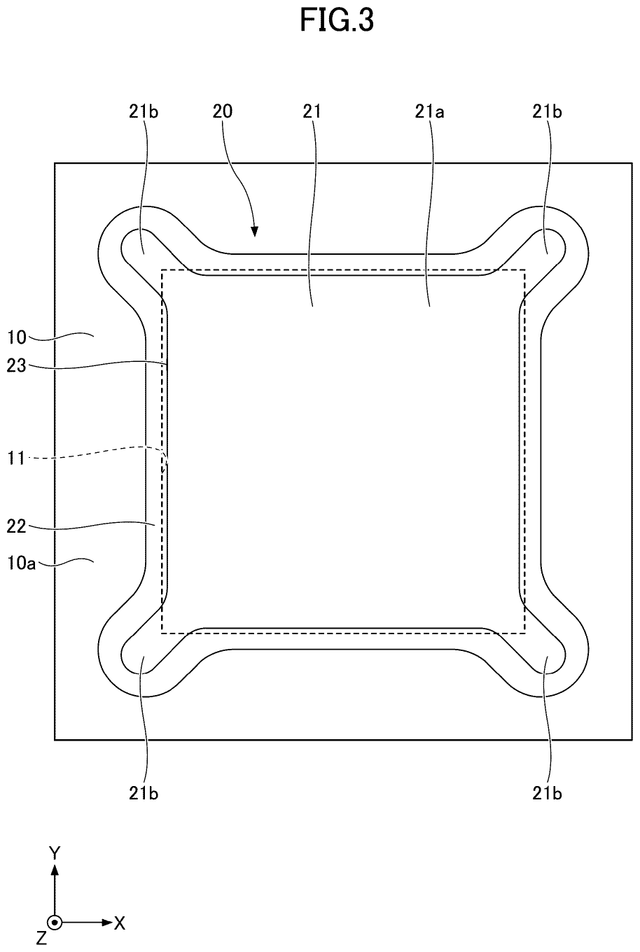

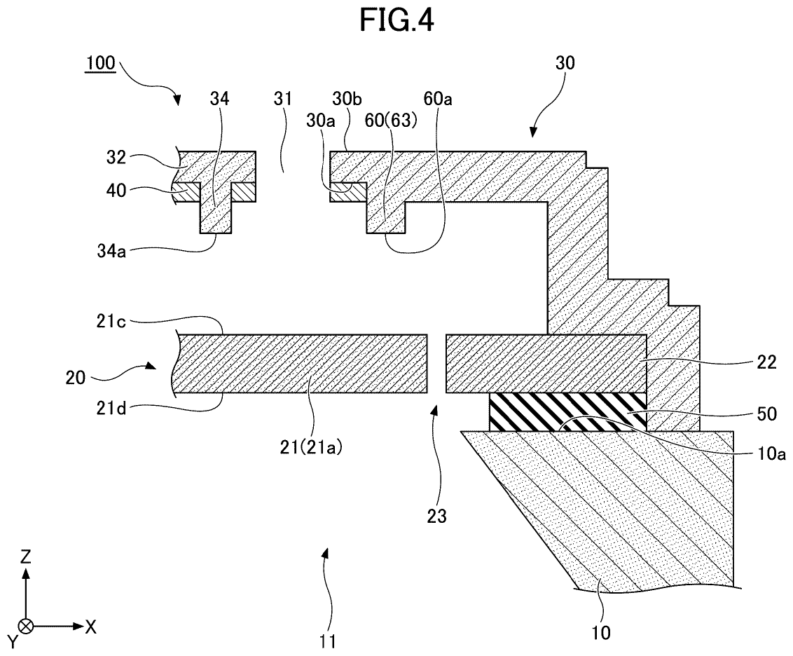

A sound conversion device according to a first embodiment 100 will be described with reference to FIGS. 1 to 4. FIG. 1 is an exploded perspective view illustrating the sound conversion device 100 according to the first embodiment. FIG. 2 is a plan view illustrating the sound conversion device 100 according to the first embodiment. FIG. 3 is a plan view illustrating a diaphragm 20. FIG. 4 is a cross-sectional view illustrating a section taken along the line IV-IV in FIG. 2. In each of the drawings, an X-axis direction, a Y-axis direction, and a Z-axis direction, which are three orthogonal directions, are illustrated. The Z-axis direction is a thickness direction of a substrate 10. The Z-axis direction may be a top-bottom direction. In the following description, terms “top” and “bottom” may be used, but the sound conversion device 100 is not limited to such an orientation. For example, with the diaphragm 20 as a reference, a side where the back plate 30 is arranged may be referred to as “top” and the side where the substrate 10 is arranged may be referred to as “bottom”. The X-axis direction includes a direction indicated by an arrow and the reverse direction. Similarly, the Y-axis direction and the Z-axis direction include the direction indicated by the arrow and the reverse direction.

As shown in FIG. 1, the sound conversion device 100 includes a substrate 10, a diaphragm 20, and a back plate 30. As shown in FIG. 4, the sound conversion device 100 includes a fixed electrode 40 and a support member 50. The sound conversion device is also referred to as an acoustic transducer. The sound conversion device 100 can be used for MEMS microphones. The sound conversion device 100 is a capacitive element manufactured using MEMS technology. “MEMS” is an abbreviation for Micro Electro Mechanical System. The sound conversion device 100 can be used for other acoustic sensors, and can be used as a speaker.

### Substrate 10

The substrate 10 is formed of, for example, single crystal silicon. The substrate 10 may be formed into a cuboid shape, for example, by dicing. A cavity 11 penetrating in the Z-axis direction is formed in the substrate 10. The cavity 11 includes an opening. The cavity 11 has, for example, a rectangular shape when viewed from the Z-axis direction. The shape of the opening of the cavity 11 is not limited to a rectangular shape, but may have other shapes. The substrate 10 has a first surface 10a and a second surface opposite each other in the Z-axis direction. The first surface 10a is a surface facing the diaphragm 20 in the Z-axis direction.

### Diaphragm 20

The diaphragm 20 has conductivity and is arranged so as to cover the cavity 11. The diaphragm 20 is a polysilicon thin film having conductivity. The diaphragm 20 is an example of a thin film. The diaphragm 20 is a vibrating electrode plate. The thickness direction of the diaphragm 20 is along the Z-axis direction. The diaphragm 20 has a movable film 21 and a fixed film 22. The movable film 21 is arranged so as to cover the cavity 11 in the Z-axis direction. As shown in FIG. 3, the movable film 21 includes a main body 21a having a substantially rectangular shape and a protrusion 21b extending outward from a corner of the main body 21a.

The main body 21a is arranged so as to overlap the cavity 11 when viewed from the Z-axis direction. As shown in FIG. 3, the protrusion 21b is arranged so as to overlap the first surface 10a of the substrate 10 when viewed from the Z-axis direction. The protrusion 21b is fixed to the first surface 10a of the substrate 10. The protrusion 21b may be fixed to the substrate 10 via a support member 50 arranged between the protrusion 21b and the first surface 10a of the substrate 10 in the Z-axis direction. The main body 21a is a portion which can vibrate in the Z-axis direction. The main body 21a is an example of a deformable part of the thin film. The protrusion 21b is an example of a fixed part of the thin film.

As shown in FIG. 4, the main body 21a of the movable film 21 has a first surface 21c and a second surface 21d opposite each other in the thickness direction (Z-axis direction) of the movable film 21. The first surface 21c is on a side facing the back plate 30, and the second surface 21d is on a side facing the cavity 11.

### Fixed Film 22

The fixed film 22 is disposed around the movable film 21 when viewed from the Z-axis direction. The fixed film 22 is formed so as to surround the movable film 21. The fixed film 22 is disposed so as to overlap the first surface 10a of the substrate 10 when viewed from the Z-axis direction. The fixed film 22 is fixed to the first surface 10a of the substrate 10 via the support member 50. Similarly, the protrusion 21b of the diaphragm 20 is fixed to the first surface 10a of the substrate 10 via the support member 50.

### Slit 23

As shown in FIGS. 3 and 4, a slit 23 is formed between the movable film 21 and the fixed film 22 in the X-axis direction and the Y-axis direction. The slit 23 is a portion where the diaphragm 20 is not present. The slit 23 is formed so as to surround the movable film 21. The slit 23 has a predetermined width. The slit 23 is formed so as to penetrate the diaphragm 20 in the Z-axis direction. The slit 23 can be formed by etching a single polysilicon film. Thus, the movable film 21 and the fixed film 22 are divided.

### Back Plate 30

As shown in FIG. 4, the back plate 30 is arranged on a side opposite to the substrate 10 with respect to the diaphragm 20 in the Z-axis direction. The back plate 30 may have a dome shape that expands toward the side opposite to the substrate 10.

The back plate 30 has a plate 32 facing the movable film 21 of the diaphragm 20 in the Z-axis direction. The thickness direction of the plate 32 is along the Z-axis direction. The plate 32 is arranged apart from the diaphragm 20 in the Z-axis direction. A predetermined space is formed between the diaphragm 20 and the plate 32. The plate 32 of the back plate 30 is arranged so as to cover the opening of the cavity 11 of the substrate 10 when viewed from the Z-axis direction.

A plurality of holes 31 penetrating in the Z-axis direction are formed in the plate 32 of the back plate 30. The plurality of holes 31 are arranged at predetermined intervals in the X-axis direction and the Y-axis direction. The plurality of holes 31 are acoustic holes (sound holes) for passing acoustic vibrations. The plate 32 of the back plate 30 has a first surface 30a and a second surface 30b opposite in the Z-axis direction. The first surface 30a is on the side of the diaphragm 20, and the second surface 30b is on the side opposite to the diaphragm 20.

The periphery of the back plate 30 is arranged at a position overlapping the first surface 10a of the substrate 10 when viewed from the Z-axis direction. The periphery of the back plate 30 is formed outside the plate 32. The periphery of the back plate 30 is disposed outside the diaphragm 20 in the X-axis direction and the Y-axis direction, and is fixed to the first surface 10a of the substrate 10.

As shown in FIG. 2, the plurality of holes 31 may be formed to form, for example, a hexagon when viewed from the Z-axis direction. The shape of the plurality of holes 31 is not limited to a hexagon, but may be circular, elliptical, rectangular, or any other polygon. The shape of the plurality of holes 31 is not particularly limited.

### Fixed Electrode 40

As shown in FIG. 4, the fixed electrode 40 is formed on the first surface 30a of the back plate 30. The fixed electrode 40 is arranged so as to face the main body 21a of the movable film 21 of the diaphragm 20 in the Z-axis direction. The fixed electrode 40 is arranged inward of the slit 23 in the X-axis direction and the Y-axis direction. The fixed electrode 40 is arranged at a position overlapping the cavity 11 of the substrate 10 when viewed from the Z-axis direction.

### Capacitance C

The diaphragm 20 and the fixed electrode 40 are arranged apart in the Z-axis direction and function as parallel plates. The main body 21a of the movable film 21 of the diaphragm 20 is a movable electrode and is displaced in the Z-axis direction by an action of sound pressure. As a result, capacitance C between the diaphragm 20 and the fixed electrode 40 changes. The sound conversion device 100 can sense sound by converting the change in the capacitance C into a voltage. The main body 21a of the movable film 21 is an example of a deformable part.

### Lateral Wall 60

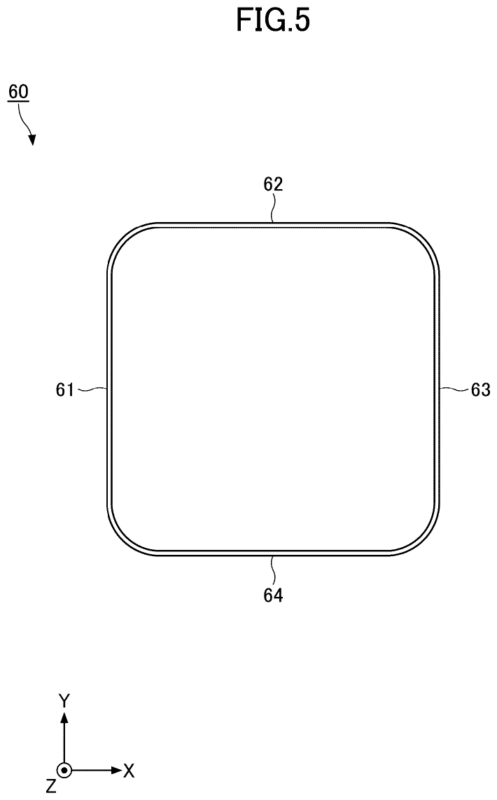

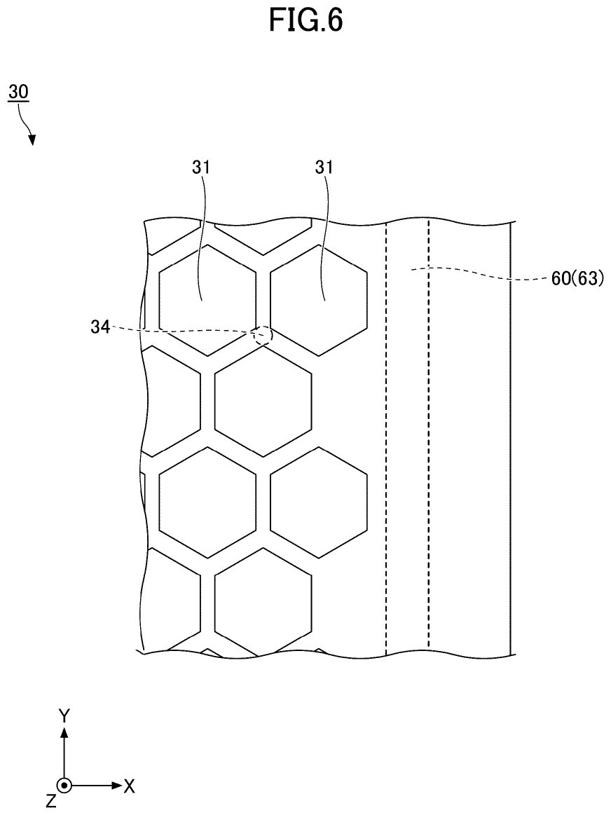

FIG. 5 is a plan view illustrating an arrangement of a lateral wall 60 formed on the back plate 30. FIG. 6 is a partially enlarged plan view illustrating an enlarged portion of the back plate 30. As shown in FIG. 2 and FIGS. 4 to 6, the back plate 30 has a lateral wall 60 extending from the plate 32 toward the movable film 21. As shown in FIG. 2, the lateral wall 60 is formed so as to surround the outside of the plurality of holes 31. The lateral wall 60 is formed so as to form a substantially rectangular outline. The plurality of holes 31 are disposed inside the lateral wall 60.

As shown in FIG. 5, the lateral wall 60 has a first side 61, a second side 62, a third side 63, and a fourth side 64. The first side 61 and the third side 63 face the X-axis direction and extend in the Y-axis direction. The second side 62 and the fourth side 64 face the Y-axis direction and extend in the X-axis direction. The first side 61, the second side 62, the third side 63, and the fourth side 64 are formed linearly in the Z-axis direction. The first side 61, the second side 62, the third side 63, and the fourth side 64 may include a curved part.

As shown in FIG. 4, the cross-sectional shape of the lateral wall 60 in the direction intersecting the longitudinal direction of the lateral wall 60 may be rectangular. The lateral wall 60 has a bottom surface 60a facing the movable film 21 in the Z-axis direction. The bottom surface 60a may be a surface parallel to an XY-plane. The bottom surface 60a may include a curved surface.

The lateral wall 60 is disposed inward of the slit 23 in the direction intersecting the thickness direction of the substrate 10. When viewed from the Z-axis direction, the position close to the center of the cavity 11 is regarded as the inside. The plurality of holes 31 are disposed inward of the lateral wall 60. The slit 23 is disposed outward of the lateral wall 60.

For example, a width of the lateral wall 60 in the direction intersecting the longitudinal direction of the lateral wall 60 may be larger than the width of the slit 23 in the direction intersecting the longitudinal direction of the slit 23.

### Stopper 34

As shown in FIGS. 4 and 6, the back plate 30 includes a plurality of stoppers 34 which are disposed inward of the lateral wall 60 in the direction intersecting the plate thickness direction of the substrate 10 (X-axis direction or Y-axis direction) and extend toward the movable film 21 in the Z-axis direction. The stopper 34 is an example of a protrusion. The stoppers 34 are disposed between the plurality of holes 31 when viewed from the Z-axis direction. The stoppers 34 are formed as points when viewed from the Z-axis direction. The stoppers 34 are shaped as, for example, circles when viewed from the Z-axis direction. The shape of the stoppers 34 is not limited to a circle, but may be rectangular or any other shape. In addition, the stoppers may be formed outside the lateral wall 60. For example, the stoppers may be formed at a position overlapping the protrusions 21b when viewed from the Z-axis direction.

As shown in FIG. 4, the cross-sectional shape of the stoppers 34 along the Z-axis direction may be rectangular. The stoppers 34 have bottom surfaces 34a opposite the movable film 21 in the Z-axis direction. The bottom surfaces 34a may be surfaces parallel to the XY-plane. The bottom surfaces 34a may include a curved surface.

In the Z-axis direction, the position of the bottom surface 60a of the lateral wall 60 may be the same as the positions of the bottom surfaces 34a of the stoppers 34. In the Z-axis direction, a distance from the first surface 21c of the movable film 21 to the bottom surface 60a of the lateral wall 60 may be the same as the distance from the first surface 21c to the bottom surface 34a of the stopper 34. Note that “same” includes “substantially the same”.

### Contact Between Lateral Wall 60 and Movable Film 21

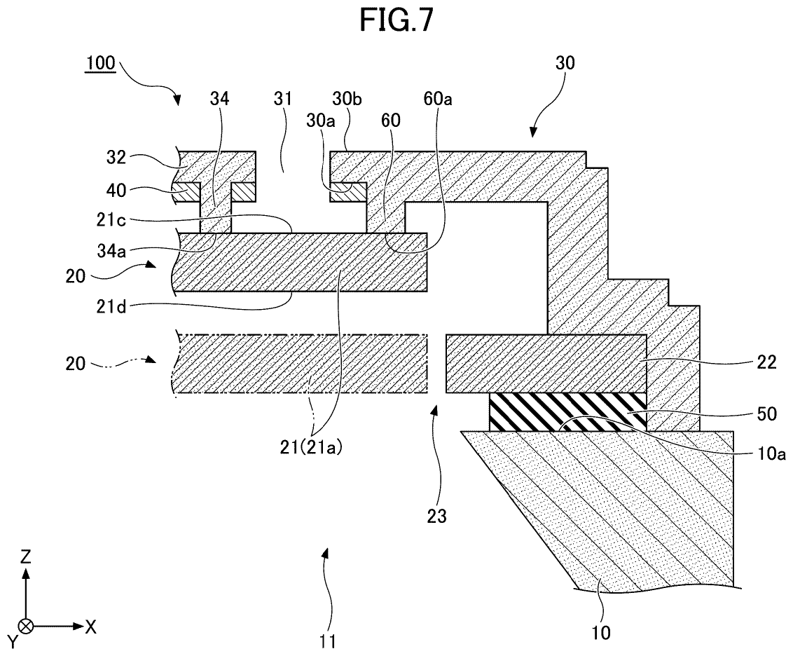

FIG. 7 is a cross-sectional view illustrating a section taken along the line IV-IV in FIG. 2, and a drawing illustrating a state in which the lateral wall 60 and the stoppers 34 are in contact with the movable film 21. As shown in FIG. 7, when the pressure in the cavity 11 rises, the movable film 21 moves in a direction approaching the back plate 30. When the pressure in the cavity 11 rises, the movable film 21 contacts the stoppers 34 and the lateral wall 60. Specifically, the first surface 21c of the movable film 21 contacts the bottom surfaces 34a of the stoppers 34 and the bottom surface 60a of the lateral wall 60. Thus, the vibration of the movable film 21 can be reduced. In FIG. 7, the movable film 21 in a state where pressure is not applied and the movable film is not displaced is shown by a chain double-dash line. In a state where the movable film 21 is in contact with the stoppers 34 and the lateral wall 60, the movable film 21 and the fixed electrode 40 are not in contact.

For example, in a state where the first surface 21c of the movable film 21 is in contact with the bottom surface 60a of the lateral wall 60, air in the cavity 11 does not flow into the plurality of holes 31. In a state where the movable film 21 is in contact with the lateral wall 60, the cavity 11 and the plurality of holes 31 are not in communication. As shown in FIG. 4, in a state where the movable film 21 is not in contact with the lateral wall 60, the cavity 11 and the plurality of holes 31 are in communication.

As shown in FIG. 7, in a state where the movable film 21 is in contact with the lateral wall 60, the second surface 21d of the movable film 21 is disposed above the first surface 22a of the fixed film 22. In this state, the opening of the slit 23 extends in the Z-axis direction. In the Z-axis direction, a gap is formed between the movable film 21 and the fixed film 22. In other words, when the movable film 21 and the lateral wall 60 are in contact, a gap is formed between the movable film 21 and the first surface 10a of the substrate 10.

### Sound Conversion Device 100B According to Comparative Example

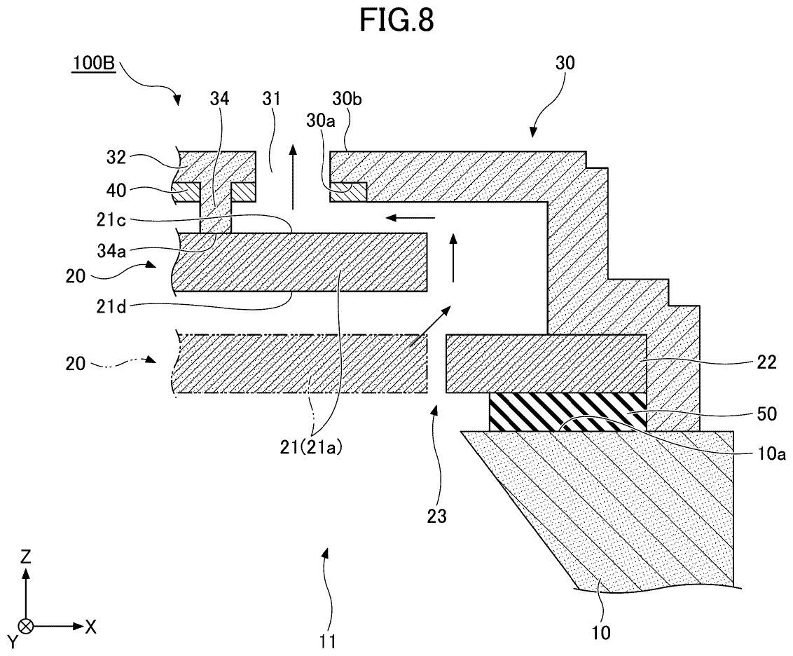

Next, the sound conversion device 100B according to a comparative example will be described with reference to FIG. 8. FIG. 8 is a cross-sectional view illustrating a sound conversion device 100B according to the comparative example. The sound conversion device 100B according to the comparative example shown in FIG. 8 differs from the sound conversion device 100 according to the first embodiment shown in FIG. 4 in that it does not have a lateral wall 60.

In the sound conversion device 100B according to the comparative example, when the pressure inside the cavity 11 rises, the movable film 21 moves in a direction approaching the back plate 30, and the movable film 21 and the stoppers 34 come into contact with each other. In this state, since the sound conversion device 100B according to the comparative example does not have a lateral wall 60, the plurality of holes 31 and the cavity 11 communicate with each other. Therefore, air in the cavity 11 flows into the plurality of holes 31 through a gap between the movable film 21 and the fixed film 22 and a gap between the first surface 21c of the movable film 21 and the back plate 30.

In the sound conversion device 100B according to the comparative example, when the pressure inside the cavity 11 rises, air flows through the plurality of holes 31. Therefore, when the pressure inside the cavity 11 is high, the vibration of the movable film 21 increases, and the movable film 21 or the back plate 30 may be damaged. For example, when the movable film 21 vibrates, the movable film 21 comes into contact with the stoppers 34, and the movable film 21 or the back plate 30 may become worn or cracked.

In the sound conversion device 100 according to the first embodiment, as shown in FIG. 7, the lateral wall 60 and the movable film 21 come into contact to prevent the flow of air into the plurality of holes 31. In the sound conversion device 100, vibration of the movable film 21 is reduced by the contact of the lateral wall 60 and the movable film 21, and damage to the diaphragm 20 and the back plate 30 can be prevented.

### Effect of Sound Conversion Device 100 According to First Embodiment

The sound conversion device 100 according to the first embodiment includes a substrate 10 having a cavity 11, a diaphragm (thin film) 20 including a main body (deformable part) 21a of the movable film 21 which is disposed to cover the cavity 11 and configured to deform in response to a change in pressure inside the cavity 11, and a protrusion (fixed part) 21b which is connected to the main body 21a and fixed to the substrate 10, and a back plate 30 which faces the movable film 21 in the Z-axis direction (in the plate thickness direction of the substrate 10), is disposed on a side opposite to the substrate 10 with respect to the movable film 21, and has a plurality of holes 31. The back plate 30 includes a plate 32 having a plurality of holes 31 and facing the movable film 21, and a lateral wall 60 disposed to surround the outside of the plurality of holes 31 and extending from the plate 32 toward the movable film 21.

In such a sound conversion device 100, when pressure is applied to the inside of the cavity 11, the movable film 21 moves in a direction approaching the plate 32 of the back plate 30 according to the increase in pressure. When the pressure inside the cavity 11 increases, the movable film 21 contacts the lateral wall 60. Thus, vibration of the movable film 21 can be reduced. Therefore, contact between the movable film 21 and the plate 32 of the back plate 30 is prevented, and damage to the movable film 21 and the back plate 30 is prevented.

In the sound conversion device 100, when a given pressure is applied to the movable film 21 in the direction from the cavity 11 toward the back plate 30, the movable film 21 deforms to approach the back plate 30 and comes in contact with the lateral wall 60. In the sound conversion device 100, when the movable film 21 is in contact with the lateral wall 60, a gap is formed between the movable film 21 and the substrate 10 in the Z-axis direction.

In the sound conversion device 100, when the given pressure is applied to the movable film 21 in the direction from the cavity 11 toward the back plate 30, the movable film 21 deforms to approach the back plate 30 and comes in contact with the lateral wall 60. When the movable film 21 is in contact with the lateral wall 60, the plurality of holes 31 are not in communication with the cavity 11. In this state, the flow of air from the cavity 11 to the plurality of holes 31 is blocked. In such a sound conversion device 100, propagation of pressure from the plurality of holes 31 is prevented, and damage to the movable film 21 due to vibration of the movable film 21 can be prevented. In the sound conversion device 100, when the pressure inside the cavity 11 is increased, the flow of air to the side of the movable film 21 opposite to the cavity 11 (side of the first surface 21c) is prevented, vibration of the movable film 21 can be reduced, and damage to the movable film 21 can be prevented.

### Sound Conversion Device 100C According to Second Embodiment

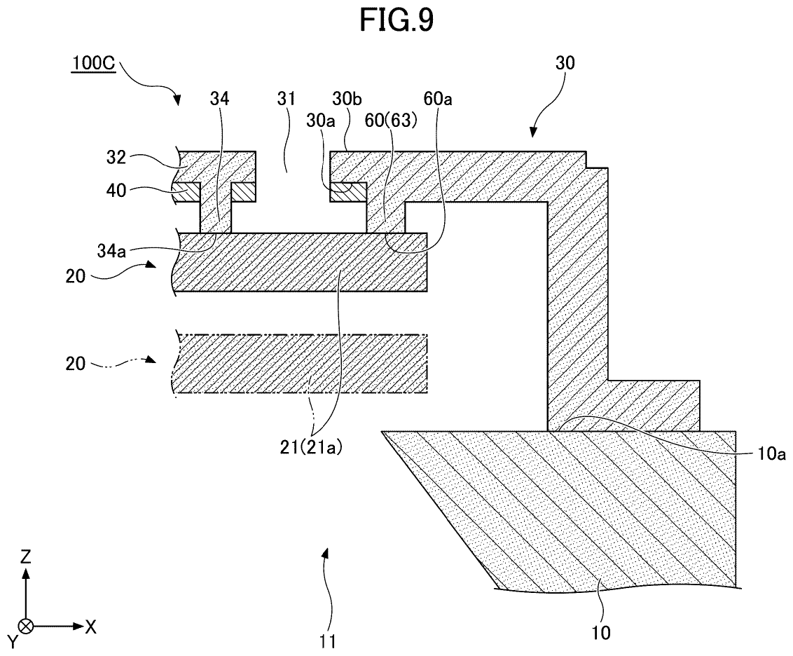

Next, a sound conversion device 100C according to a second embodiment will be described. FIG. 9 is a cross-sectional view illustrating a sound conversion device 100C according to the second embodiment, and a drawing illustrating a state in which a lateral wall 60 and stoppers 34 are in contact with a movable film 21. The sound conversion device 100C according to the second embodiment shown in FIG. 9 differs from the sound conversion device 100 according to the first embodiment shown in FIG. 7 in that it does not include a fixed film 22. In the description of the sound conversion device 100C according to the second embodiment, the same description as that of the sound conversion device 100 according to the first embodiment is omitted.

In the sound conversion device 100C according to the second embodiment, the diaphragm 20 may have a movable film 21 and is not required to have a fixed film 22. The sound conversion device 100C according to the second embodiment has the same operation and effect as that of the sound conversion device 100 according to the first embodiment.

The diaphragm 20 is not required to have a slit 23. The movable film 21 of the diaphragm 20 may be larger than the opening of the cavity 11 in the Z-axis direction. The outer edge of the movable film 21 may be disposed at a position overlapping the substrate 10 when viewed from the Z-axis direction. The sound conversion device 100C according to the second embodiment is not required to have a support member 50.

### Sound Conversion Device 100D According to Third Embodiment

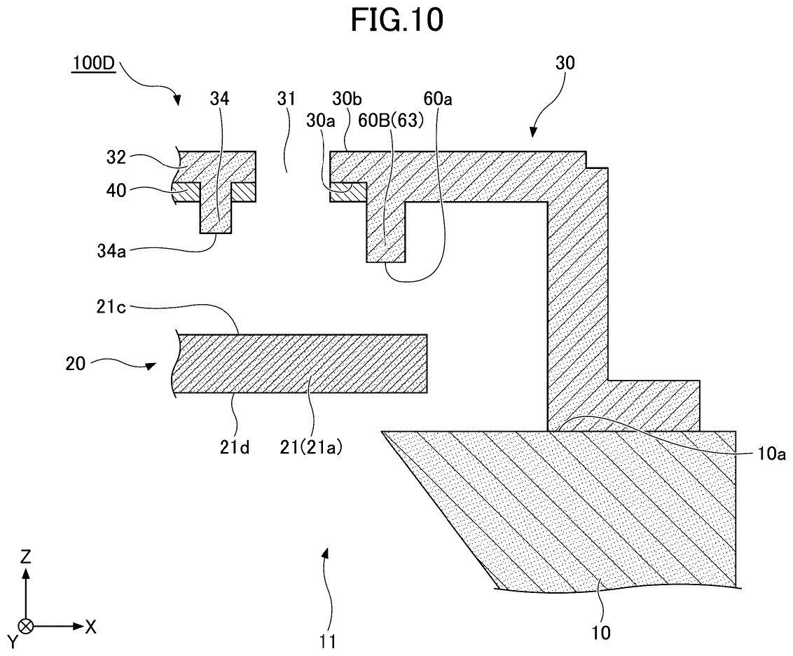

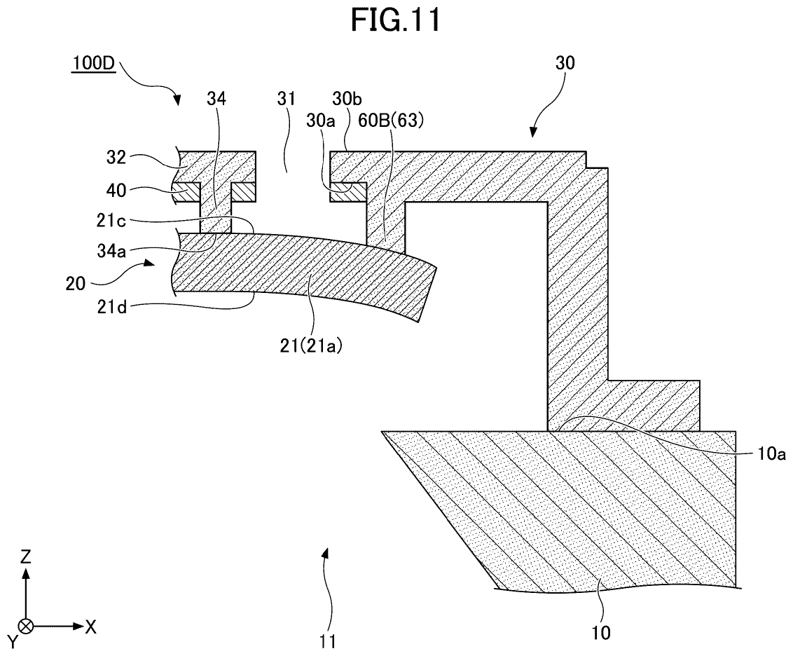

Next, a sound conversion device 100D according to the third embodiment will be described. FIG. 10 is a cross-sectional view illustrating a sound conversion device 100D according to the third embodiment. FIG. 11 is a cross-sectional view illustrating the sound conversion device 100D according to a third embodiment, and a drawing illustrating a state in which a lateral wall 60B and stoppers 34 are in contact with the movable film 21. The sound conversion device 100D according to the third embodiment shown in FIG. 10 differs from the sound conversion device 100C according to the second embodiment shown in FIG. 9 in that the lateral wall 60B is provided instead of the lateral wall 60. In the description of the sound conversion device 100D according to the third embodiment, the same description as that of the sound conversion device 100 and 100C according to the above-mentioned embodiment is omitted.

The lateral wall 60B extends in the Z-axis direction further than the stoppers 34. The bottom surface 60a of the lateral wall 60B is disposed, in the Z-axis direction, at a position closer to the substrate 10 (closer to the movable film 21) than the bottom surfaces 34a of the stoppers 34. The bottom surface 60a of the lateral wall 60B is an example of a tip of the lateral wall. The bottom surface 34a of the stopper 34 is an example of a tip of the protrusion.

As shown in FIG. 11, when the pressure inside the cavity 11 increases, the movable film 21 is displaced in a direction approaching the plate 32 of the back plate 30. When the pressure inside the cavity 11 increases, the movable film 21 comes into contact with the stoppers 34 and the lateral wall 60B. Specifically, the first surface 21c of the movable film 21 comes into contact with the bottom surfaces 34a of the stoppers 34 and the bottom surface 60a of the lateral wall 60B. In this state, the movable film 21 is bent. The first surface 21c of the movable film 21 comes into contact with the bottom surface 60a of the lateral wall 60B.

The sound conversion device 100D according to the third embodiment has the same operation and effect as the sound conversion device 100 according to the first embodiment. The protrusion amount of the lateral wall 60B in the Z-axis direction may be different from the protrusion amount of the stopper 34. The position of the bottom surface 60a of the lateral wall 60B and the positions of the bottom surfaces 34a of the stoppers 34 may be different in the Z-axis direction.

### Sound Conversion Device 100 According to Fourth Embodiment

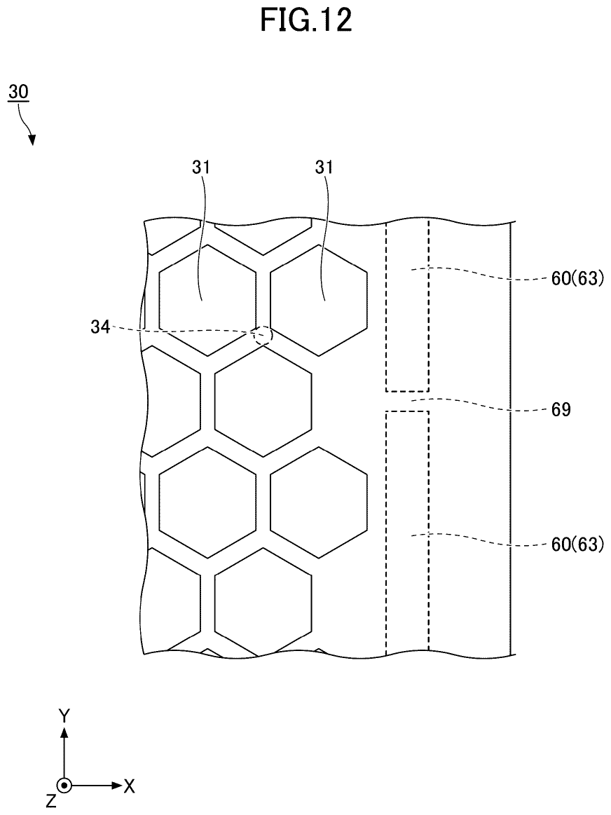

Next, the sound conversion device 100 according to a fourth embodiment will be described. FIG. 12 is a partially enlarged plan view illustrating an enlarged portion of a back plate 30 of a sound conversion device 100 according to the fourth embodiment. The sound conversion device 100 according to the fourth embodiment differs from the sound conversion device 100 according to the first embodiment in that an opening 69 is formed in a lateral wall 60. In the description of the sound conversion device 100 according to the second embodiment, the same description as that of the sound conversion device 100 according to the first embodiment will be omitted.

In the sound conversion device 100 according to the fourth embodiment, the lateral wall 60 is not required to be continuous around the entire periphery. For example, an opening 69 may be formed on a third side 63 of the lateral wall 60. The third side 63 may be divided longitudinally. The opening 69 is a portion where the lateral wall 60 is not formed. The opening 69 penetrates the lateral wall 60, for example, in the X-axis direction. The position, size, and quantity of the opening 69 are not particularly limited.

The sound conversion device 100 according to the fourth embodiment has the same operation and effect as the sound conversion device 100 according to the first embodiment. By forming the opening 69, when the movable film 21 and the lateral wall 60 are in contact, some air can pass through the opening 69. Thus, the pressure inside the cavity 11 can be adjusted, and the pressure acting on the movable film 21 can be adjusted. The lateral wall 60 may have an opening through which air can pass.

### MEMS Microphone 101 According to Fifth Embodiment

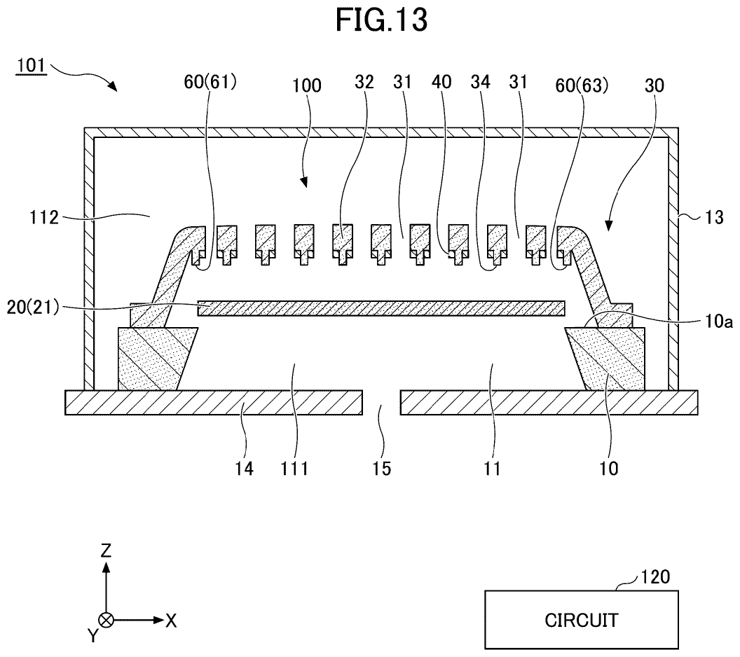

Next, a MEMS microphone 101 according to a fifth embodiment will be described. FIG. 13 is a cross-sectional view illustrating the MEMS microphone 101 according to the fifth embodiment. The MEMS microphone 101 includes the sound conversion device 100 according to the above-described embodiment. The MEMS microphone 101 may include sound conversion devices 100C and 100D instead of the sound conversion device 100. In the description of the MEMS microphone 101 according to the fifth embodiment, the same description as that of the sound conversion devices 100, 100C, and 100D according to the above-described embodiment will be omitted.

The MEMS microphone 101 includes a sound conversion device 100, a housing 13, a bottom plate 14, and a circuit 120.

The circuit 120 is electrically connected to a diaphragm 20 which is a movable electrode and a fixed electrode 40. The circuit 120 converts the change of the capacitance C between the diaphragm 20 and the fixed electrode 40 into a voltage signal. The circuit 120 outputs the converted signal to the outside of the circuit 120.

The housing 13 has an opening and accommodates the sound conversion device 100. The housing 13 may be box-shaped. The housing 13 is arranged so as to cover the sound conversion device 100 from the back plate 30 side. The bottom plate 14 is disposed so as to close the opening of the housing 13. The sound conversion device 100 is arranged in a space surrounded by the housing 13 and the bottom plate 14. The thickness direction of the bottom plate 14 is along the Z-axis direction. The bottom plate 14 is arranged so as to close the bottom surface of the substrate 10. The bottom plate 14 is arranged on the opposite side of the substrate 10 from the diaphragm 20. A sound hole 15 which is a through-hole is formed in the bottom plate 14.

A first space 111 and a second space 112 are formed inside the housing 13. The first space 111 is a space between the diaphragm 20 and the bottom plate 14. The second space 112 is a space between the diaphragm 20 and the housing 13.

Thus, the sound conversion device 100 can be applied to the MEMS microphone 101.

### MEMS Microphone 101B According to Sixth Embodiment

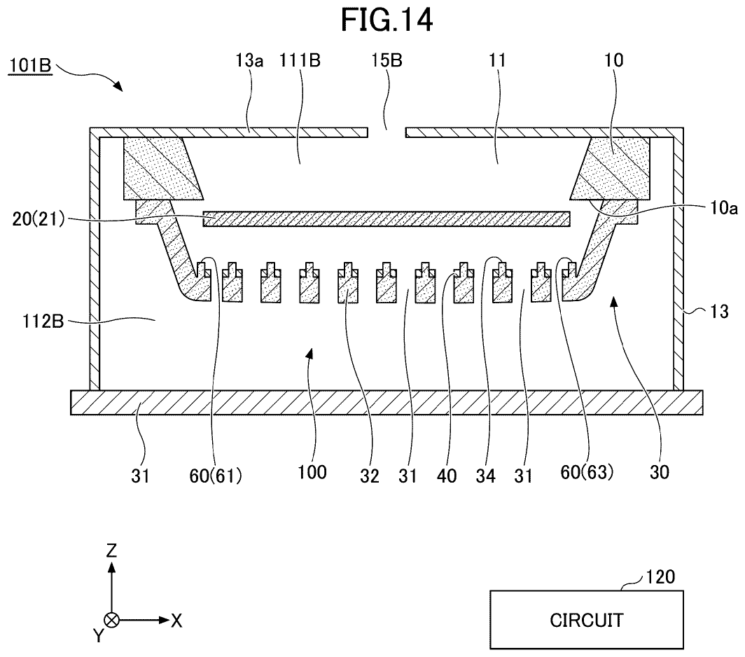

Next, the MEMS microphone 101B according to the sixth embodiment will be described. FIG. 14 is a cross-sectional view illustrating the MEMS microphone 101B according to the sixth embodiment. The MEMS microphone 101B according to the sixth embodiment differs from the MEMS microphone 101 according to the fifth embodiment in the arrangement of the sound conversion device 100 and the sound hole 15B. In the description of the MEMS microphone 101B according to the sixth embodiment, descriptions of the MEMS microphone 101B that are the same with respect to the sound conversion devices 100, 100C, and 100D according to the above-described embodiment will be omitted.

The MEMS microphone 101B includes a housing 13 and a bottom plate 14. A sound hole 15B is formed in the housing 13. The housing 13 has a top plate 13a facing the bottom plate 14 in the Z-axis direction. A sound hole 15B penetrating in the plate thickness direction is formed in the top plate 13a.

The substrate 10 of the sound conversion device 100 is attached to the top plate 13a of the housing 13. The sound hole 15B communicates with the cavity 11. The back plate 30 of the sound conversion device 100 is disposed opposite to the top plate 13a (closer to the bottom plate 14) with respect to the substrate 10.

A first space 111B and a second space 112B are formed inside the housing 13. The first space 111B is a space between the diaphragm 20 and the top plate 13a of the housing 13. The second space 112B is a space between the diaphragm 20 and the bottom plate 14.

Further, the present invention is not limited to these embodiments, and various variations and modifications may be made without departing from the scope of the present invention.

### Sound Conversion Device 100 According to Modified Example

In the sound conversion device 100 according to a modified example, the cross-sectional shape of the bottom surface 60a of the lateral wall 60 is not limited to a plane parallel to the XY-plane. The bottom surface 60a of the lateral wall 60 may include a curved surface, a projection, a recess, a step surface, or a slope. The lateral wall 60 may be formed so as to be divided into a plurality in the longitudinal direction of the lateral wall 60. For example, the projection formed on the bottom surface 60a may be continuous in the longitudinal direction of the lateral wall 60. For example, the recess formed on the bottom surface 60a may be continuous in the longitudinal direction of the lateral wall 60 and may be formed so as to penetrate the lateral wall 60 in the width direction. For example, the slope formed on the bottom surface 60a may be formed so that the outer end extends from the plate 32 further than the inner end in the width direction. For example, the curved surface formed on the bottom surface 60a may be formed so as to gradually extend from the plate 32 in the width direction from the inner end to the outer end. The “width direction” is a direction that intersects the longitudinal direction when viewed from the Z-axis direction. It should be noted that the “inside” is closer to the center of the opening of the cavity 11 when viewed from the Z-axis direction, and the “outside” is farther from the center of the opening of the cavity 11.

What is claimed is

1. A sound conversion device comprising:
a substrate having a cavity;
a thin film including:
a deformable part disposed to cover the cavity and configured to deform in response to a change in pressure inside the cavity; and
a fixed part connected to the deformable part and fixed to the substrate; and
a back plate facing the thin film in a thickness direction of the substrate, disposed on a side opposite to the substrate with respect to the thin film, and having a plurality of holes formed in the back plate,
wherein the back plate includes:
a plate having the plurality of holes and facing the thin film; and
a lateral wall disposed to surround the plurality of holes, and extending from the plate toward the thin film.

2. The sound conversion device according to claim 1, wherein:
when a pressure is applied to the thin film in a direction from the cavity toward the back plate, the deformable part deforms to approach the back plate and comes in contact with the lateral wall; and
when the deformable part is in contact with the lateral wall, a gap is formed between the deformable part and the substrate in the thickness direction of the substrate.

3. The sound conversion device according to claim 1, wherein:
when a pressure is applied to the thin film in a direction from the cavity toward the back plate, the deformable part deforms to approach the back plate and comes in contact with the lateral wall; and
when the deformable part is in contact with the lateral wall, the plurality of holes are not in communication with the cavity.

4. The sound conversion device according to claim 1, wherein an opening penetrating the lateral wall in a direction intersecting the thickness direction of the substrate is formed.

5. The sound conversion device according to claim 1, wherein:
the back plate has a protrusion that extends toward the thin film in the thickness direction of the substrate; and
a tip of the lateral wall is disposed, in the thickness direction of the substrate, at a position closer to the thin film than is a tip of the protrusion.

6. A microphone comprising:
the sound conversion device of claim 1; and
a circuit configured to output a signal output from the sound conversion device to an outside.

7. The microphone according to claim 6, further comprising:
a housing having an opening and configured to accommodate the sound conversion device; and
a bottom plate configured to close the opening of the housing, wherein:
a through-hole penetrating either the housing or the bottom plate in the thickness direction of the substrate and communicating with the cavity is formed; and
a first space defined between the thin film and the housing or the bottom plate in which the through-hole is formed; and
a second space defined between the thin film and the housing or the bottom plate in which the through-hole is not formed, are formed within the housing.
